(19) United States
(12) Patent Application Publication
(10) Pub. No.: US 2004/0210739 A1
(43) Pub. Date: Oct. 21, 2004

(54) Vector signal processor

(76) Inventors: Yung-Po Huang, Taipei (TW); Che-Hui Chang-Chien, Taipei (TW); Chao-Yuan Huang, Taipei (TW); Chiung-Hung Chang, Taoyuan Hsein (TW)

Correspondence Address: Chauncey Johnson, Johnson & Associates PC, 14625 Baltimore Ave #282, Laurel, MD, 20707, US

(21) Appl. No.: 10/336,860

(22) Filed: Jan. 6, 2003

(51) Int. Cl. G06F 15/00

(52) U.S. Cl. 712/2; 712/25

(57) ABSTRACT

A vector signal processor of the present invention consisting of a digital signal processor unit, a VSP command bus, a data flow interface, a broadcast interface, a multi-channel buffered serial port (McBSP) network, and a host interface. The vector signal processor of this invention has high processing speed, better communication between modules, far better coordination, and uses daughter cards to enhance various processing functions.

### BACKGROUND OF THE INVENTION

1. Field of th Invention

The present invention relates to a module design of a vector signal processor. More specifically, the present invention uses a plurality of digital signal processor (DSP) chips, for example 4 DSP chips, to operate as a module processing center. The module processing speed and the efficiency of data exchange among the DSPs are high. These processor units are furnished with semaphore and interruptible functions. The plurality of module chips are also furnished with broadcast share memory, and any one of the modules may update said broadcast share memory. The host provides high transparency control bus in order to manage a certain range of data controlled by the processor chips, including program codes of the signal processor unit, and provides mail box and module interruptible status to the four sets of DSP. Furthermore, in order to enhance the signal processor chips function, each processor unit is furnished with slots for daughter cards to render a better solution to its operational effect and expansion capacity of the vector signal processor modules.

2. Related Prior Art

Various vector signal processor module of the related prior art such as the Pentek Model 4290/4291 uses four sets of high performance DSP chips as processing center, and is furnished with slots for daughter cards to enhance the system's performance and module expansion capacity. However, related prior arts, such as the Pentek Model 4290/4291 is limited in many ways: (1) there is no common shared resources and communication mechanism for other modules to access through broadcast or sharing measures; (2) the host is unable to manage all status of each module, thus being incapable to provide the most effective resource schedule and access; and (3) during mass data handling by the processing center, it is found that data route and software operation may consume tremendous time and postpone other important jobs due to lack of the appropriate flow schedule and hardware auxiliary operation measures, which is normally unacceptable for high caliber system operation.

### SUMMARY OF THE INVENTION

An object of the module design vector signal processor of the present invention is to solve problems associated with the prior art, such as lack of shared resources and communication mechanism, inability to manage status for each module, consumption of significant amount of time, and postponement of important task.

Another object of this invention is to provide a module design of a vector signal processor of the present invention comprising digital signal processor units for processing vector signal processor data; a VSP command bus, a global bus connecting the host interface, digital signal processor units, arbitrator/mail box and flash memory components.

Still, another object of this invention is to provide a module design of a vector signal processor further comprising a data flow interface, a register of the vector signal processor modules for queued data from the digital signal processor unit to be routed; a broadcast interface, a register of the vector signal processor modules for routing shared data of each module, and a transmitting and a receiving port. As one of the modules updates its own memory data will at the same time update the rest of the modules at the same memory address via the transmitting and receiving ports.

Still further, another object of this invention is to provide a module design of a vector signal processor of further comprising a McBSP network, which is a crossbar network design allowing each adjacent and non adjacent digital signal processor units to route data, a host interface is a communication interface between host and vector signal processor modules, an arbitrator/mail box arbitrating the privilege of using VSP command bus and mail box waiting for the access of the host; and a flash memory divided mainly into an application area and a user area of the digital signal processor units.

The present invention will be readily apparent upon reading the following description of a preferred exemplified embodiment of the invention and upon reference to the accompanying drawings.

### BRIEF DESCRIPTION OF DRAWINGS

FIG. 1 illustrates the system function block diagram of the vector signal processor of the present invention.

FIG. 2 illustrates the digital signal processor unit configuration of the vector signal processor of the present invention.

FIG. 3 illustrates the VSP command bus processing flow diagram of the vector signal processor of the present invention.

FIG. 4 illustrates the data flow interface processing flow diagram of the vector signal processor of the present invention.

FIG. 5 illustrates the control circuit of the vector signal processor of the present invention for managing SRAM access.

FIG. 6 illustrates the ring configuration design of dual ports RAM of vector signal processor of the present invention.

### DETAILED DESCRIPTION OF THE PREFERRED EMBODIMENTS

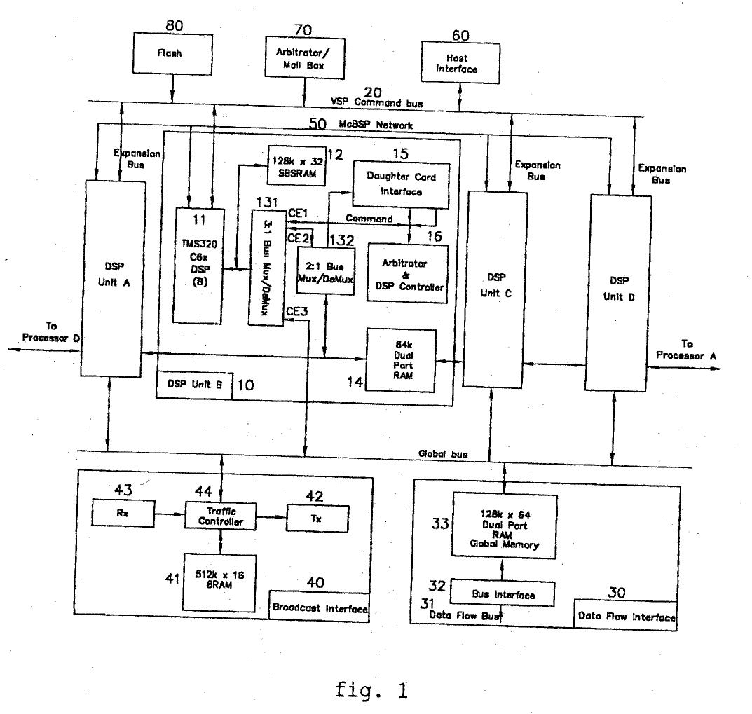

Referring to FIG. 1, a system function block diagram of the vector signal processor of the present invention consisting of four sets of the digital signal processor (DSP) unit 10, a VSP command bus 20, a data flow interface 30, a broadcast interface 40 and a multi-channel buffer serial port (McBSP) network 50.

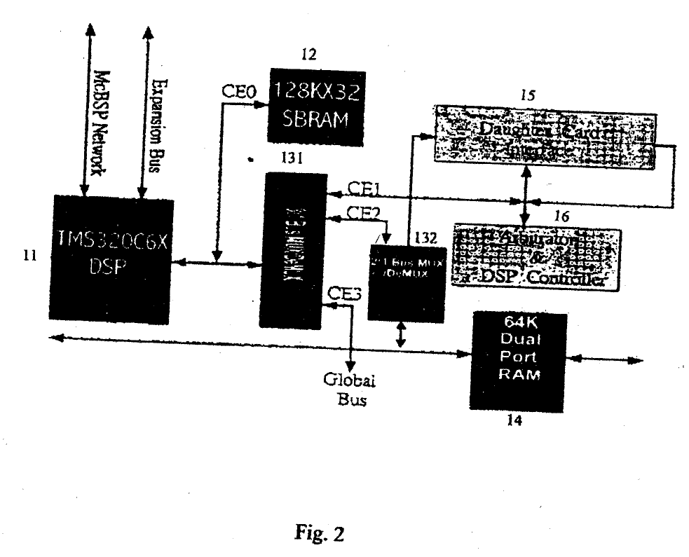

FIG. 2, as shows a digital signal processor unit configuration of the vector signal processor of the present invention, wherein said digital signal processor unit 10 consist of a TI TMS320C6x-DSP chip 11, a synchronization burst memory (SBSRAM) 12, a data switch circuit 13, a dual port RAM 14, a daughter card interface 15 and a DSP controller 16.

Referring to FIG. 2. the TI TMS320C6x-DSP uses a DSP chip uses a TI TMS320C6202-200 MHz DSP chip as a processing center for the module processing units, which is capable of being substitute or upgraded at least one level higher on demand. The SBSRAM 12 uses 512K Byte (128K×32 bit), which may be substituted or upgraded if the needs arises. The Data switch circuit 13 includes a 3:1 bus Mux/DeMux 131 and a 2:1 bus Mux/DeMux 132. Finally, the dual port RAM 14 uses 256K byte (64K×32 bit) and may be substituted or upgraded should a need arise.

The vector signal processor module of the present invention includes four sets of identical DSP unit 10. The memory map of said DSP units 10 is divided into four address divisions CE0, CE1, CE2 and CE3 respectively, wherein the SBSRAM 12 uses the CE0 address division, the daughter card control bus and the preset codes of the DSP controller 16 uses the CE1 address division, the local dual RAM 14 and the adjacent dual RAM 14 use the CE2 address division, and the whole global bus uses the CE3 address division.

Each digital processor unit 10 has its discrete independent functions, but can route data to one another through dual port RAM 14, semaphore and McBSP network 50, wherein the dual port RAM 14 and semaphore are configured in a ring path, and the McBSP network 50 is a crossbar network. The digital signal processor unit 10 of the vector signal processor module has its own internal program and data memory provided by the TI TMS320C6x-DSP chip 11. Besides, the digital signal processor unit 10 also requires external hook up memory SBSRAM 12 which can also be adopted as a program and data memory of the digital signal processor unit 10.

Still referring to FIG. 2, the digital signal processor unit 10 daughter car interface 15 is capable of increasing or expanding the handling capacity of the processor chips, and if a pulse suppression daughter card is added in the digital signal processor unit 10 is capable of controlling said daughter card to read and process data through the dual port RAM 14 and the result sent back to the processor.

The data switch circuit 13 consists of two Bus Mux/DeMux circuit blocks: a 3:1 Bus Mux/DeMux 131 and a 2:1 Bus Mux/DeMux 132. The 3:1 Bus Mux/DeMux 131 is in charge of coordinating the access path switch of the processor to dual pot RAM 14 and the Global bus, and the data path switch of the processor to the daughter card. Similarly, the 2:1 bus and the Mux/DeMux 132 are responsible for handling the access path switch of the processor and the daughter card to the dual port RAM 14.

The DSP controller 16 of digital signal processor unit 10 is in charge of the daughter card control, the data exchange preset and the arbitration privilege of using the global bus for four sets of digital signal processor unit 10. The global bus is a shared data bus on which there are four sets of digital signal processor unit 10, broadcast interface 40 and data bus interface 30. The four sets of digital signal processor unit 10 actively use the global bus, whereas the broadcast interface 40 and data bus interface 30 are passive components. Therefore, each digital signal processor unit 10 requires arbitration to select a processor to use the global bus.

The vector signal processor module of the present invention is not equipped with a daughter card but per se but is equipped provides with a daughter card interface 15. In FIG. 2, the daughter card interface 15 is connected to the controlling line of DSP controller 16 and two sets of bus: a control bus and a data bus. The daughter card switches path via 2:1 Bus Mux/DeMux 132 and then retrieves data through dual port RAM 14, or may receive written commands or parameters from the processor through the control bus of CE1 and routes the processed data to the processor. Besides, DSP controller 16 may provide software reset signal and may enable/disable signal to the daughter card. DSP controller 16 also receives commands from the processor and issue various control signals to the daughter card, and each digital signal processor unit 10 has equipped dual port RAM 14.

As shown in FIG. 1, one set of the data port of the dual port RAM 14 has connection with its own processor and the other set of the data port of said dual port RAM 14 has connection with the adjacent processor. For example, the set A's digital signal processor unit 10 can write or read its own set's dual port RAM 14 and also set D's dual port RAM 14 of set D's digital signal processor unit 10, and the set C's digital signal processor unit 10 can write or read its own set's dual port RAM 14 and set B's dual port RAM 14 of set B's digital signal processor unit 10.

The dual port RAM 14 can be used for data exchange with adjacent processor, or can be used as a memory expansion with the other dual port RAM 14.

Referring FIG. 1, VSP command bus 20 is a shared bus on which there is host interface 60, four sets of digital signal processor unit 10, arbitrator/mail box 70 and flash memory 80. The four sets of digital signal processor unit 10 may read/write flash memory 80 or mail box 70 only after successful arbitration by arbitration circuit 70, and the host communicates data with the processor chips of the four digital signal processor units 10 through host interface 60.

In a preferred embodiment of the present invention, the communication of host interface 60 between host and vector signal processor module uses 32 bits communication interface which can be upgraded on actual demand. The vector signal processor module acts as a slave to a host, which acts as a master capable of connecting plurality of modules. The host may actively issue command to any one of the digital signal processor unit 10 to control command, data and read returned data or status value. The module may provide interruptible signal to interrupt the host through OR wired connection and return processed status.

The host interface 60 and four sets of digital signal processor unit 10 are active components on the VSP command bus, and the use privilege is arbitrated with arbitrator 70. Flash memory 80 and mail box 70 are passive component, which will not occupy the use privilege of the command bus. Host interface 60 and four sets of digital signal processor unit 10 are first required to use the arbitrator circuit to obtain the use privilege before using the VSP command bus.

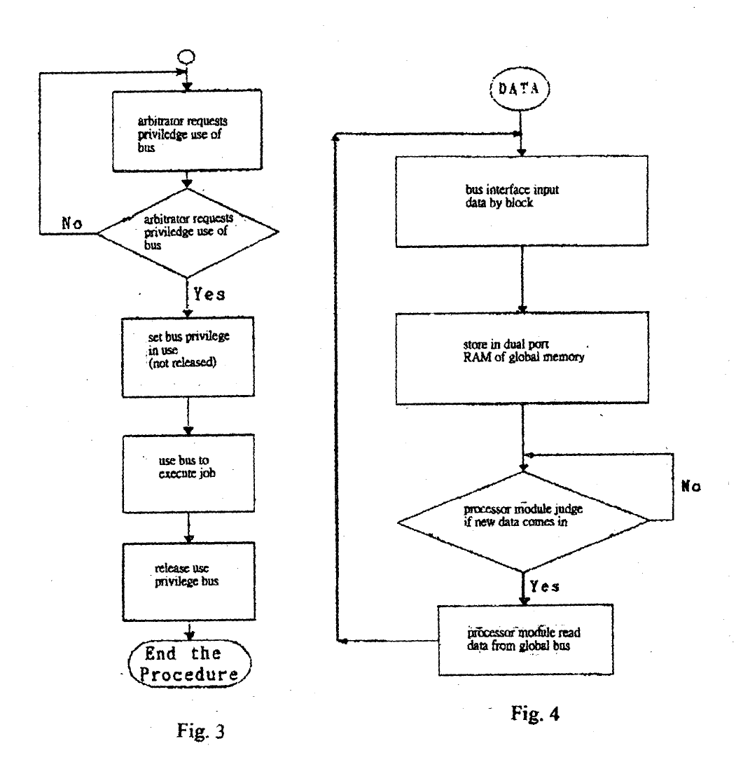

The flow diagram in FIG. 3 demonstrates the manner of handling the VSP command bus of the vector signal processor of the present invention. The ranking use privilege of the VSP command bus follows a certain order. First, host interface 60; second, set a digital signal processor unit 10; third, set B digital signal processor unit 10; fourth, set C digital signal processor unit 10; and fifth set D digital signal processor unit 10. Because the host actively retrieves the host interface 60, when the processor units are using the VSP command bus, the arbitrator circuit will issue Not Ready (HRDY not active) to the host until the DSP releases the use privilege of the bus. When host interface 60 or digital signal processor unit 10 request the arbitrator to grant use privilege for using the VSP command bus, and if the privilege is not released it means the VSP command bus is not available. However, if the privilege of the VSP command bus is released, it means the VSP command bus is available, and is allowed to set use privilege for job execution. After the job is done, the use privilege of the VSP command bus is released again to other users. The four sets of the digital signal processor unit 10 are all furnished with mail box 70, which may discretely send message to the host and the message will be stored in the register of the mail box 70 for the host to read. The Interruptible status register will automatic record the sent messages from the four sets of digital signal processor unit 10 for the host to read.

Flash memory 80 is a non-volatile read/write memory mainly divided into an application program division and a user division for four sets of digital signal processor unit 10. Flash memory 80 in a preferred embodiment uses 4M byte (1024K×32 bit) and could readily be upgraded on demand.

Again, referring to FIG. 1, four sets of digital signal processor unit 10 make use of broadcast interface 40 and data flow interface 30 via the global bus as a register of the vector signal processor module of the present invention. The register store two kinds of data. The first type of data is to be processed by four sets of digital signal processor unit 10 of the vector signal processor modules, wherein said data is placed in the dual port RAM 33 of data flow interface 30. The other type of data is data for sharing between modules, which is placed in the SRAM of broadcast interface 40 and the bus used for data flow interface 30, where the broadcast interface 40 is the CE3 bus of the processor. Data flow interface 30 includes data flow bus 31, bus interface 32 and dual port RAM 33 used for input data register, where the data bandwidth of data flow bus 31 is capable of reaching 160 Mbyte and being upgraded on demand. The Dual port RAM 33 of bus flow interface 32 now uses 1 Mbyte (128K×64 bit), but is capable of being upgraded on demand. External data may be inputted into the vector signal processor modules of the present invention via the data flow bus 31, which is a synchronization bus, and may actively input external data by blocking dual port RAM 33 of the processor modules. When the vector signal processor modules detects data inputted, it must read the data before the next data input or the data will be updated.

FIG. 4 describes the data flow interface 30 of the present invention. Referring to FIG. 4, the Broadcast interface 40 includes broadcast share memory (SRAM) 41, transmit port 42, receiving port 43 and traffic controller 44. The function of the broadcast interface 40 is to route shared data among modules, and when one of modules has updated its own memory data, the former will at the same time update the memories at the same address for the rest of modules through transmit port 42 and receiving port 43.

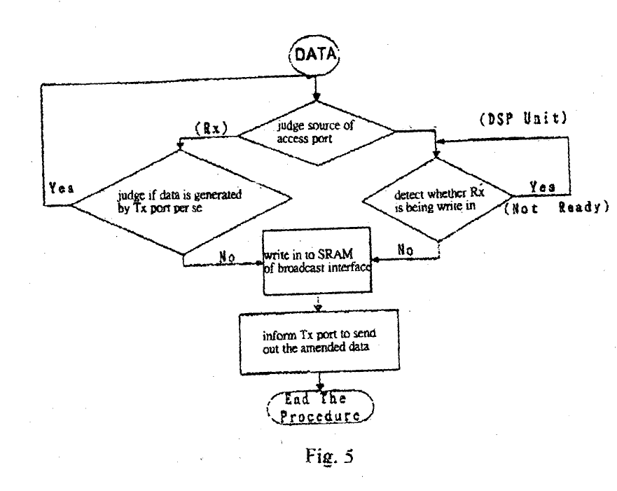

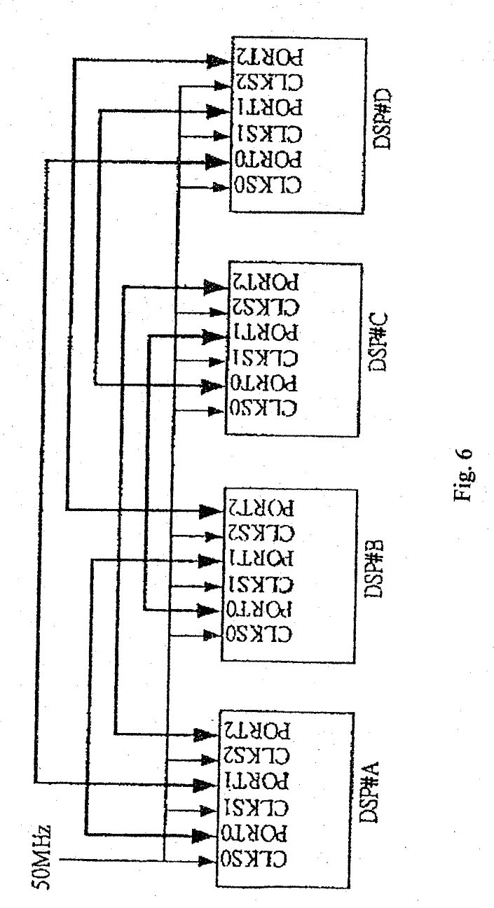

FIG. 5 describes how control circuit 44 effectively manages the SRAM 41 access and availability. Dual port RAM 14 of the four sets of digital signal processor unit 10 has a ring configuration design, and only routes data from adjacent digital signal processor unit 10. However, FIG. 6 shows a MCBSP network capable of providing an alternative path, which not only allows each adjacent digital signal processor unit 10 route data, but also let those non adjacent digital signal processor unit 10 route data. Such crossbar network design makes each processor unit face each other during data routing.

The aforementioned features of the vector signal processor modules of the present invention is advantageous in at least six ways:

First, the broadcast interface 40 provides routing information amongst the modules and because the vector signal processor modules have the configuration of the broadcast interface 40, when one broadcast interface 40 memory of a certain module is updated, the broadcast interface 40 memory of the rest of modules are updated accordingly. Such a communication mechanism enhances the interaction and coordination among modules, thus making operation efficient.

Second, the control end of the host may access any one of the digital signal processor unit processor unit 10 through host interface 60, access memory data of broadcast interface 40 and data flow interface 30. Furthermore, design of the control end and the mail box 70 of the module allows the control end to manage all status and information in the modules with ease, and thus the resources of the modules can be well scheduled and utilized. Such an arrangement allows for controlling the bus transparency.

Third, daughter card slots enable the daughter cards to reduce operation time. The designed daughter card is inserted in the daughter card slot to share the processor chips load burden. The designed daughter card retrieves the dual port RAM of the digital signal processor unit 10 and efficiently contributes to the improvement of the data routing process.

Also, the digital signal processor unit 10 will not loose any order of schedule while handling mass data, and the daughter card design can satisfy the desired needs which can not be fulfilled using software in certain areas.

Fourth, the vector signal processor modules of the present invention uses four DSP chips with high performance, and the processing speed as a whole may reach 6400 Mega MIPS and above.

The digital signal processor unit 10 is capable of being substituted with more sophisticated processors to improve efficiency. Current DPS speed is 200 MHz, but the module speed as a whole may reach 6400 Mega Mips and above if the DPSs are modified or upgraded. Such a set-up always guarantee high processing speed and efficiency

Fifth each digital signal processor unit 10, except for directly routing data through a MCBSP network, is capable of completing data routing by using its own dual port RAM 14 and the next adjacent dual port RAM 14. By using dual port RAM14 to route data allows each data processing unit to hold data among DSP chips, unlike FIFO (first in first out), where the data would be lost once being retrieved. Further the fact that the dual port RAM 14 and MCBSP network matches each other makes the digital signal processor unit 10 not only advantageously efficiency but also the expandable quantity as well.

Sixth and finally the daughter card slots are capable of expanding and enhancing the processor chips functions. The daughter slot inserted with various functional daughter cards may render vector signal processor modules capable of handling a variety of functions. In order to speed up retrieval, daughter card slots allow daughter cards to directly read the dual port RAM 14 of the digital signal processor unit 10. Such an arrangement allow the daughter card slots allow daughter cards to be expandable and capable of enhancing the function of processor chips by maintaining processing efficiency.

In a preferred embodiment, the present invention developed a correlating card, which was inserted in the daughter card slot for testing purposes. It was found that the execution time is only about one twelfth of the software execution time. The experiment used 256 reference codes and 2510 cells data inputted into the vector signal processor modules of the present invention, the results revealed are as follows:

| | software execution | software execution |
|---|---|---|
| | without daughter card | with daughter card (together |
| | (used assembly language | with correlating daughter |
| | program) | card auxiliary operation) |
| time | 3220 micro-second | 258 micro-second |
| consumed | | |

Various additional modification of the embodiments specifically illustrated and described herein will be apparent to those skilled in the art in light of the teachings of this invention. The invention should not be construed as limited to the specific form and examples as shown and described. The invention is set forth in the following claims.

What is claimed is:

1. A vector signal processor comprising:
digital signal processor units for processing data of said vector signal processor;
a VSP command bus, a global bus connecting host interface, digital signal processor units, arbitrator/mail box and flash memory components;
a data flow interface, a register of said vector signal processor modules for queued data of digital signal processor unit to be routed;
a broadcast interface, a register of said vector signal processor modules for routing shared data of each module;
a transmitting port and receiving port, which are use such that as one of said modules update its own memory data the rest of modules will be updated simultaneously at the same memory address via said transmitting and receiving port;
a McBSP network, which is a crossbar network design allowing each adjacent and non adjacent digital signal processor units to route data;
a host interface, which is a communication interface between host and said vector signal processor modules;
an arbitrator/mail box arbitrating the privilege of using VSP command bus and mail box while waiting for the access of host; and,
a flash memory divided mainly into an application and a user area of said digital signal processor units.

2. The vector signal processor as in claim 1, wherein said digital signal processor unit consist of TI TMS320C6x-DSP chips, a SBSRAM memory, a data exchange circuit, a dual port RAM, DSP controller, and a daughter card interface.

3. The vector signal processor as in claim 1, wherein said digital signal processor unit adopts four sets or more in plurality combination.

4. The vector signal processor as claim 2, wherein TMS320C6x-DSP chips use TI TMS320C6202-200 MHz DSP chips, which can be substituted or upgraded on demand.

5. The vector signal processor in claim 2, wherein said SBSRAM memory uses 100 MHz synchronization burst memory with 512K Byte, which can be substituted or upgraded on demand.

6. The vector signal processor as claimed in item 2, wherein data exchange circuit including 3:1 bus Mux/DeMux and 2:1 bus Mux/DeMux.

7. The vector signal processor as in claim 6, wherein
said 3:1 Bus Mux/DeMux is in charge of coordinating the access path switch of said processor to said dual pot RAM and said global bus, and the data path switch of said processor to a daughter card.

8. The vector signal processor as in claim 6, wherein
and said 2:1 Bus Mux/DeMux is in charge of handling the access path switch of said processor and said daughter card to said dual port RAM.

9. The vector signal processor as in claim 2, wherein
said DSP controller is in charge of a daughter card control, data exchange preset and the arbitration of use privilege for using said global bus for said four sets digital signal processor unit.

10. The vector signal processor as claimed in item 2, wherein
the daughter card slot may insert with designed daughter card to share load burden of processor chips.

11. The vector signal processor as in claim 10, wherein
said daughter card interface, and said designed daughter card retrieve dual port RAM of said digital signal processor unit and improves efficiency for mass data routing.

12. The vector signal processor as n claim 1, wherein the
data flow interface includes data flow bus, bus interface and dual port RAM use for input data register.

13. The vector signal processor as in claim 12, wherein
data bandwidth of said data flow bus may reach 160 Mbyte and may be upgraded on demand.

14. The vector signal processor as claimed in item 12, wherein
dual port RAM of said bus flow interface uses 1 Mbyte (128K×64 bit) and may be upgraded on demand.

15. The vector signal processor as in claim 1, wherein broadcast interface includes broadcast share memory (SRAM), transmitting port, receiving port and traffic controller.

16. The vector signal processor as in claim 15, wherein
said control circuit manage the access of broadcast share memory SRAM.
